(19) United States
(12) Patent Application Publication
(10) Pub. No.: US 2016/0371410 A1
(43) Pub. Date: Dec. 22, 2016

(54) METHOD FOR MODELING ARTICLES AND MANUFACTURING THE ARTICLE

(71) Applicant: The Procter & Gamble Company, Cincinnati, OH (US)

(72) Inventor: Douglas Joseph Meyer, Cincinnati, OH (US)

(21) Appl. No.: 15/183,908

(22) Filed: Jun. 16, 2016

Related U.S. Application Data
(60) Provisional application No. 62/181,512, filed on Jun. 18, 2015.

(51) Int. Cl. G06F 17/50; G06T 17/20

(52) U.S. Cl. CPC G06F 17/5009; G06T 17/20

(57) ABSTRACT

A method for modeling an absorbent article that includes creating a three dimensional computer based predictive simulation of the absorbent article comprised of a mesh made of one or more nodes is disclosed. The method may be used in the creation of absorbent articles.

### FIELD OF THE INVENTION

In general, the present disclosure relates to computer based models allowing for the customization of an article in a real time, interactive, three-dimensional shape modification interface that allows for the evaluation of a design or the functional qualities of the design. The system then allows for the manufacturing of the modeled article based on the chosen modifications within the computer based model. In particular, the present disclosure relates to computer based models for the customization of an article in real time using a three-dimensional shape modification system that allows for ordering the customized article.

### BACKGROUND OF THE INVENTION

It has been a common practice to improve upon products by receiving input from consumers. However, often consumers may not be able to articulate what they desire and a visual aid is helpful. The visual aid is ideally in the form of a finished product. However, the manufacturing of different samples to be shown can be a costly endeavor. Further, such aides do not allow for the consumer to modify the product in real time while allowing them to see a finished product.

Due to the issues above, one may turn to a simulation. However, simulations have traditionally been in two dimensions and do not allow for the versatile modifications that are within the realm of what may be manufactured.

As a result, it would be beneficial to develop a method that allows one to simulate the appearance of a three dimensional product form while allowing the consumer to interact and modify the three dimensional form. Specifically, it would be beneficial to simulate various physical aspects and components of a product in a three dimensional form such that, once simulated, it could be requested and manufactured. This model can then be used to create an improved product to have the desired physical characteristics. It would also be beneficial to be able to manipulate the simulation while showing how the manipulations impact the physical product.

### SUMMARY OF THE INVENTION

A method for making an absorbent article. The method includes creating a computer based three dimensional simulation of an absorbent article comprised of a mesh made of one or more nodes, building one or more deformation parameters for one or more discrete product attributes, defining output requirements for the predictive three dimensional simulation, rendering one or more frames of the predictive simulation appearance model, and using the computer based predictive simulation to create the absorbent article.

A method of simulation for an absorbent article using a computer. The method includes creating a computer based three dimensional simulation of an absorbent article comprised of a mesh made of one or more nodes, building one or more deformation parameters for one or more discrete product attributes, defining output requirements for the predictive three dimensional simulation, rendering one or more frames of the predictive simulation appearance model, utilizing an iterative logic in response to one or more user inputs, allowing the iterative logic to adapt one or more design parameters to predict user input, and rendering one or more frames of an updated predictive simulation appearance model.

A method of simulation for an absorbent article using a computer. The method includes creating a computer based three dimensional simulation of an absorbent article comprised of a mesh made of one or more nodes, building one or more deformation parameters for one or more discrete product attributes, defining output requirements for the predictive three dimensional simulation, rendering one or more frames of the predictive simulation appearance model, allowing one or more users to manipulate one or more physical attributes of the model, utilizing an iterative logic in response to one or more user inputs, allowing the iterative logic to adapt one or more design parameters to predict user input, and rendering one or more frames of an updated predictive simulation appearance model.

### BRIEF DESCRIPTION OF THE DRAWINGS

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate various embodiments described herein, and together with the description serve to explain the principles and operations of the claimed subject matter.

FIG. 1 is a chart illustrating a method for modeling the article.

FIG. 2 is a chart illustrating a computer system.

FIGS. 3A-F represent various possible tabs.

FIG. 4 is a representation of a three dimensional model and a user interface.

### DETAILED DESCRIPTION

As used herein, “absorbent article” refers to a device or implement that has the capacity to uptake and to release a fluid. An absorbent article can receive, contain, and absorb bodily exudates (e.g. urine, menses, feces, etc.). Absorbent articles include absorbent articles placed inside the body, in particular tampons and the like. Other non-limiting examples of absorbent articles include absorbent articles worn next to the human body, in particular sanitary napkins, panti-liners, interlabial pads, diapers, pull-on diapers, training pants, incontinence products, toilet tissue, paper towels, facial tissue, wound dressings, and the like.

As used herein, “boundary conditions” are defined variables that represent physical factors acting within a computer based model. Examples of boundary conditions include forces, pressures, velocities, and other physical factors. Each boundary condition may be assigned a particular magnitude, direction, and location within the model. These values may be determined by observing, measuring, analyzing, and estimating real world physical factors. Computer based models may also include one or more boundary conditions that differ from real world physical factors to account for inherent limitations in the models and to more accurately represent the overall physical behaviors of real world things, as will be understood by one of ordinary skill in the art. Boundary conditions may act on the model in various ways, to move, constrain, and deform one or more parts in the model.

As used herein, “initial conditions” are defined variables that represent initial factors acting within a computer based model.

As used herein, a “predictive simulation” relates to a computational simulation related to an item that may flow over time wherein the method utilizes nodes, particles, or a parameterized surface that may be tracked within a material. Materials may include a fluid or a solid. Predictive simulation utilizes physics based properties including quantifiable physical quantities related to the material that may be measured in a real world scenario. Quantifiable physical quantities include but are not limited to, for example, modulus and density. A predictive simulation requires outputs beyond position that affect the material such as, for example, stress, strain, and temperature. An example of a “predictive simulation” is Finite Element Analysis (FEA).

As used herein, “transitive mapping software” refers to software that allows for one-to-one correspondence of the artwork pixels across all the geometry frames, including the final one.

Values disclosed herein as ends of ranges are not to be understood as being strictly limited to the exact numerical values recited. Instead, unless otherwise specified, each numerical range is intended to mean both the recited values and any integers within the range. For example, a range disclosed as “1 to 10” is intended to mean “1, 2, 3, 4, 5, 6, 7, 8, 9, and 10.”

Embodiments disclosed herein include methods of simulating a three dimensional product such as an absorbent article on a user to change physical characteristics of the article and determine how the different physical aspects of the product will interact with the consumer. In an embodiment, the method simulates how an absorbent article will fit a user when the absorbent article is being used. The absorbent article may have graphics on the exterior, the interior, or may have an outer wrapping comprising graphics. The present disclosure assists in predicting the visual aspect of the absorbent article created by its physical components and how changes in the physical components may impact the consumer during use. As a result, an absorbent article may be modeled in a manner that allows the consumer to modify the absorbent article to their desired fit and request the article for manufacturing.

Also included is a computing device that includes a memory component that stores logic that causes the system to receive a computer based simulation of an absorbent article. The logic simulates physical changes within the absorbent article that are controlled by the user of the simulation.

Also included is a non-transitory computer-readable medium that stores a program that when executed by a computing device causes the computing device to receive a computer based simulation an absorbent article. The system then simulates modifications to different physical characteristics of the absorbent article in a three dimensional form. In an embodiment, the system may extract one or more frames of finite element analysis to establish mapping of the physical characteristics and the geometry. Alternatively, the system may determine intermediate states artistically.

Computer aided engineering (CAE) is a broad area of applied science in which technologists use software to develop computer based models that represent real world things. The models can be transformed to provide information about the physical behavior of those real world things, under certain conditions and over particular periods of time. With CAE, the interactions of the computer based models are referred to as simulations. Sometimes the real world things are referred to as a problem and the computer based model is referred to as a solution.

Commercially available software can be used to conduct CAE. ABAQUS, LS-DYNA™, Fluent, from ANSYS™, Inc. in Canonsburg, Pa., Flow3D™, from Flow Science, Inc. in Santa Fe, N. Mex., and FeFlow™ from DHI-WASY in Berlin, Germany are examples of commercially available CAE software. Other commercially available software includes Maya, 3DS Max, Cinema 4D, and Houdini. The current method may also utilize a commercially available 3D runtime engine traditionally used for games or other 3D content presentations such as, for example, Unreal, Crysis, Unity, VirTools, and combinations thereof. ABAQUS™, LS DYNA™, ANSYS™, and MARC™ are examples of commercially available Structural Analysis software. The Structural Analysis software may utilize finite element analysis (FEA). In FEA, models representing mechanical articles, as well as their features, components, structures, and/or materials are transformed to predict stress, strain, displacement, deformation, and other mechanical behaviors. FEA represents a continuous solid material as a set of discrete elements. In FEA, the mechanical behavior of each element is calculated, using equations that describe mechanical behavior. The results of all of the elements are summed up to represent the mechanical behavior of the material as a whole.

Alternatively, CAE software or any derivative such as FEA software can be written as custom software or may be open source code software. FEA and CAE software can be run on various computer hardware, such as, for example, a personal computer, a minicomputer, a cluster of computers, a mainframe, a supercomputer, or any other kind of machine on which program instructions can execute to perform functions.

Graphic rendering relates to the addition of graphics to an image or data structure. The image or data structure may include geometry, viewpoint, texture, lighting, and shading information as a description of the virtual scene. Commercially available graphic rendering tools may be used to simulate the graphics on a package. Such tools include, for example, Maxwell®, Mental Ray® and Vray®.

CAE models utilizing graphic rendering tools can represent a number of real world things, such as an absorbent article either on a user or by itself and all of the physical components of the absorbent article.

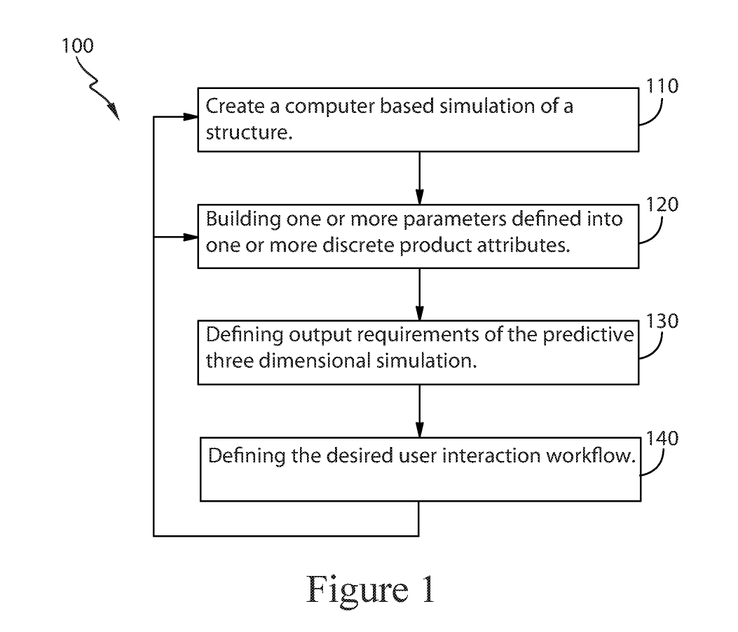

Referring now to the drawings, FIG. 1 shows a simplified flowchart of one embodiment of the present invention for generating and rendering a 3-D model of an absorbent article. As shown in FIG. 1, the method 100 may include steps 110-130 for using computer based model to create three dimensional models of absorbent articles.

The method 100 includes a first step 110 of creating a computer based simulation of a structure. The simulation may be comprised of a mesh made of one or more nodes wherein the form or structure has a surface. The mesh may be created based upon a three dimensional scan of the structure. The structure or form may be represented by an absorbent article on a user or without a user.

The form or structure may be made of a flexible material. The article material may be stretchable. The article material may comprise of more than one layer. The computer based model may comprise nodes. The nodes may be used to create a one-to-one correspondence between nodes in the initial state and nodes in the final simulation. Representing an absorbent article may include inputting initial parameters for the absorbent articles. Initial parameters may include dimensions for one or more physical aspects of the simulated absorbent article, such as, for example, the dimensions of the landing strip.

Initial parameters for the absorbent article may include any information related to the dimensions of different physical aspects of the absorbent article, such as, for example without limitation, the size of tape tabs, the size of a landing strip, the placement of elastics, the width of the absorbent core, the length of the absorbent core, the surface area of the article.

The method further includes building one or more parameters defined into one or more discrete product attributes 120. Building the deformation parameters may be done via linear or nonlinear mesh, mesh targeting, shape target blending, mesh influencing, kinematics, texture blending, and combinations thereof. Building the deformation parameters may include combining influence input shape targets defined by the technical product designer and parametric deformation to achieve the desired parameter space for one to design within. Building the deformation parameters may utilize traditional viewport Open GL shading or final-render quality presentation using CPU, GPU, or cloud-based rendering methods.

The method further includes defining the output requirements of the predictive three dimensional simulation 130. Defining the output requirements of the simulation may include collecting the design parameters selected by the users within the model environment and outputting the selections to a web page.

The method further includes defining the desired user interaction workflow 140. The user interaction workflow may be a set of sliders that control each modifiable product attribute, simple switches buttons, or combinations thereof. The interaction workflow may enable the user to remove or add components to the three dimensional model. The interaction workflow may enable the user to modify physical characteristics using the sliders. The interaction workflow may allow the user to save one or more design options. The interaction workflow may allow the user to request that the design option be manufactured. The interaction workflow may allow for iterative logic and computation in response to iterative user input, adapting the design parameter space in response to direction from the user or in an effort to predict user input. The model may then contain logic allowing it to iterate its design either within or beyond the boundaries of the initial defined design space, in effort to achieve an optimal design.

Manipulating the model and the model's modifiable product attributes may occur through the use of a user interface that allows the user to change aspects of the model, such as, for example, allowing the user to specify one or more parts of the surface where the user desires the mesh to be finer than in other parts, changing aspects of the graphics, and manipulating the shape of physical aspects of the article such as, for example, different characteristics of the fastener or different characteristics of the tab. Manipulating the model's modifiable product attributes may allow for the manipulation of the various physical attributes of the virtual article model such as, for example, one or more tabs, one or more fasteners, one or more backears, one or more nonwoven layers, one or more fastening target areas, one or more core elements, one or more graphical elements, cues, or designs. A user may be allowed to modify the predictive simulation appearance model prior to using the computer based predictive simulation to create the absorbent article.

Different characteristics may include various aspects of the physical attributes. Examples of Different characteristics related to the fastener or the tab may include, the fastener position, the top height of the fastener, the bottom height of the fastener, the stretch height of the fastener, the squaring of the fastener, the curve direction of the fastener. Different physical characteristics of the tab may include, for example, the end curve direction of the tab, the mid swoop of the tab, the squareness of the tab, the end roundness of the tab, the waviness of the tab, the wavelength of the tab, or the tab color. It is understood that the characteristics specified are illustrative examples for the tab and fasteners and not a limiting example. One of ordinary skill would recognize that each physical attribute of the article would have a known list of characteristics that may be manipulated according to the model.

In an embodiment the method may be used to determine the perception of the article by a user to qualify what the user considers an acceptable appearance and physical characteristics. In an embodiment, the user does not control the model. The model may continue deforming physical characteristics of the article based on predetermined parameters until the consumer states that the article is no longer acceptable. Determining the perception of the article by a user may be done at a computer storing the method or through a connection allowing the method to be stored on a server and accessed by the user. In an embodiment, the user initiates the method creating the predictive simulation of the absorbent article. The user then gives input to the method determining if the appearance is acceptable. When deemed acceptable, the method may further deform the article and request input from the user. The process may repeat until the user deems the appearance unacceptable. The method may be repeated with a plurality of users to determine an acceptable range for each of the physical parameters being modified on the three dimensional absorbent article.

The simulated three dimensional absorbent article can be used in virtual consumer tests to evaluate consumer acceptance for different physical aspects of the absorbent article. The information may be used in the design of absorbent articles to improve upon the absorbent article.

If the output is not as desired by the user, one embodiment of the method provides a user interface for the user to interact with the model and enter information to change the parameters used in step 110, step 120, or step 130 and repeat the process.

The method includes a first step of creating a computer based simulation of an absorbent article comprised of a mesh made of one or more nodes wherein the absorbent article 300 has a surface 110.

The computer based model may be created as described below, with general references to a computer based model of the absorbent article. A computer based model that represents the absorbent article may be created by providing dimensions and material properties to the modeling software and by generating a mesh for the absorbent article using meshing software. A mesh is a collection of small, connected polygon shapes that defines the set of discrete elements in a CAE computer based model. It is understood that he shapes may be two-dimensional, three-dimensional, or a combination of both. The type of mesh and/or the size of elements may be controlled with user inputs into the meshing software, as will be understood by one of ordinary skill in the art.

A computer based model of the absorbent article may be created with dimensions that are similar to, or the same as, dimensions that represent parts of a real world absorbent article. These dimensions may be determined by measuring actual samples, by using known values, or by estimating values. Alternatively, a model of an absorbent article may be configured with dimensions that do not represent a real world absorbent article. For example, a model of an absorbent article may represent a new variation of a real world absorbent article or may represent an entirely new absorbent article. In these examples, dimensions for the model may be determined by varying actual or known values, by estimating values, or by generating new values. The model may be created by putting values for the dimensions of parts of the absorbent article into the modeling software.

The computer based model of the absorbent article may be created with material properties that are similar to, or the same as, material properties that represent a real world absorbent article. These material properties may be determined by measuring actual samples, by using known values, or by estimating values. Alternatively, a model of an absorbent article may be configured with material properties that do not represent a real world absorbent article. For example, a model of a package may represent a new variation of a real world absorbent article or may represent an entirely new absorbent article. In these examples, material properties for the model may be determined by varying actual or known values, by estimating values, or by generating new values.

The computer based model of the absorbent article may be created with a mesh for the surface of the absorbent article. In an embodiment, an external surface of the absorbent article may be created by using shell elements, such as linear triangular elements (also known as S3R elements) with an element size of about less than 10 mm such as, for example, less than 5 mm, less than 4 mm, less than 3 mm, less than 2 mm, and 1.5 millimeters. Also, a material may be created by using solid elements, such as linear hexahedral elements (also known as C3D8R elements) with an element size of about 1.5 millimeters.

Many data structures are possible for representing the mesh of the absorbent article. In one embodiment, a data structure for the absorbent article: representing the parts by a set of nodes, and for the connected edges, classifying the edges of the polygons into connection nodes, wherein two edges that are in the same connection node have end-points on the same node.

Establishing mapping between the artwork and the geometry ensures that the color information on the package or product stretches and wrinkles accurately according to the displacements and strains in the simulated geometry. Establishing mapping between the artwork and the geometry include assigning a portion of the graphics to previously determined nodes. The graphics may be manipulated to fit the entire surface of the package or product, or a portion of the package or product. The graphics may be mapped to the surface mesh such that they are stretched or strained at the same rate as the mesh. Mapping the graphics to the mesh allows the graphics to be represented under “real world” conditions while showing the impact of the good inside the package or product on the visual representation of the graphics.

In an embodiment, steps 120 and 130 may be done simultaneously such that the method produces a series of frames as the absorbent article is altered wherein each frame shows the absorbent article.

The method may process a final rendering. The final rendering may be created by physics based rendering software, such as, for example, Maxwell by Next Limit. The physics based rendering software may simulate light transport using virtual lights that illuminate a virtual product as seen by a virtual camera to generate photo-real images of the absorbent article. The physics based rendering software may be integrated into the graphic rendering software, a plug-in to the graphic rendering software, or may be a separate program. Visual material properties may be assigned to process a final render.

In an embodiment, assigning visual material properties and processing a final rendering may account the impact on appearance caused by the physical changes of the absorbent article. The impact on appearance caused by the deformations may include, for example, changes in opacity, changes in color, change in a level of glossiness, change in a level of intensity, or combinations thereof.

Manipulating the model may include entering different attributes through a user interface. The user interface provides the user with an interactive tool operative to change one or more parameters of the modeled absorbent article.

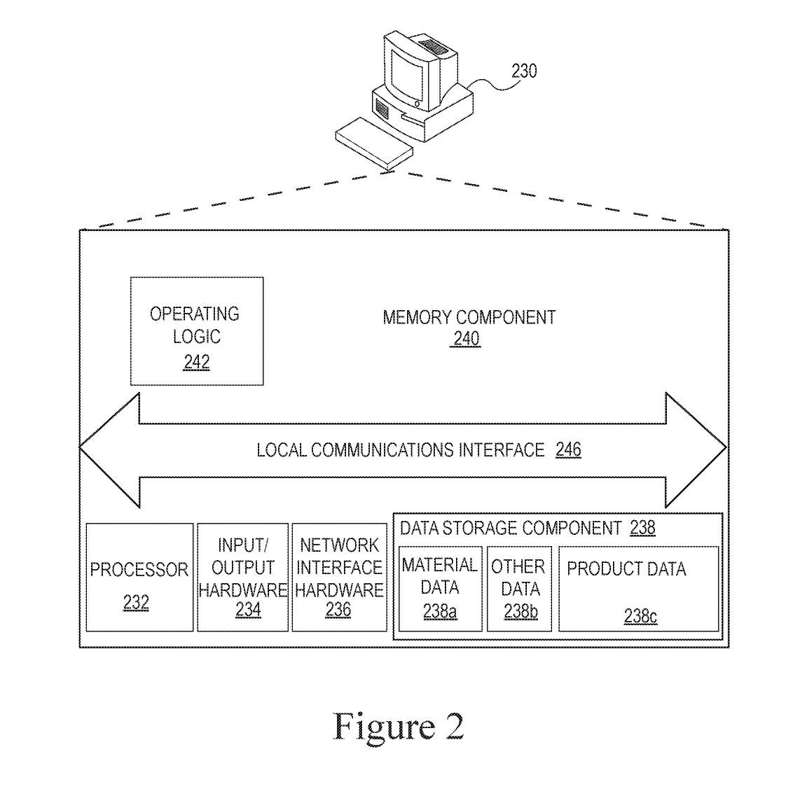

FIG. 2 depicts a computing device 230 according to systems and methods disclosed herein. The computing device 230 includes a processor 232, input/output hardware 234, network interface hardware 236, a data storage component 238 (which stores material data 238a, other data 238b, and virtual product data 238c), and a memory component 240. The computing device 230 may comprise a desktop computer, a laptop computer, a tablet computer, a mobile phone, or the like.

The memory component 240 of the computing device 230 may be configured as volatile and/or nonvolatile memory and, as such, may include random access memory (including SRAM, DRAM, and/or other types of RAM), flash memory, registers, compact discs (CD), digital versatile discs (DVD), and/or other types of non-transitory computer-readable mediums. Depending on the particular configuration, these non-transitory computer-readable mediums may reside within the computing device 230 and/or external to the computing device 230.

The memory component 240 may be configured to store operating logic 242 that may be embodied as a computer program, firmware, and/or hardware, as an example. The operating logic 242 may include an operating system, web hosting logic, and/or other software for managing components of the computing device 230. A local communications interface 246 is also included in FIG. 2 and may be implemented as a bus or other interface to facilitate communication among the components of the computing device 230.

The processor 232 may include any processing component operable to receive and execute instructions (such as from the data storage component 238 and/or memory component 240). The input/output hardware 234 may include and/or be configured to interface with a monitor, keyboard, mouse, printer, camera, microphone, speaker, and/or other device for receiving, sending, and/or presenting data. The network interface hardware 236 may include and/or be configured for communicating with any wired or wireless networking hardware, a satellite, an antenna, a modem, LAN port, wireless fidelity (Wi-Fi) card, WiMax card, mobile communications hardware, and/or other hardware for communicating with other networks and/or devices. From this connection, communication may be facilitated between the computing device 230 and other computing devices.

It should be understood that the data storage component 238 may reside local to and/or remote from the computing device 230 and may be configured to store one or more pieces of data for access by the computing device 230 and/or other components. In some systems and methods, the data storage component 238 may be located remotely from the computing device 230 and thus accessible via a network. The data storage component 238 may be a peripheral device external to the computing device 230.

It should be understood that the computing device components illustrated in FIG. 2 are merely exemplary and are not intended to limit the scope of this disclosure. While the components in FIG. 2 are illustrated as residing within the computing device 230, this is merely an example. In some systems and methods, one or more of the components may reside external to the computing device 230. The simulation, code utilized to run the simulation, or code utilized to represent any part of the simulation may be read from a computer readable media separate from the computer. It should also be understood that, while the computing device 230 in FIG. 2 is illustrated as a single system, this is merely an example. In some systems and methods, the modeling functionality is implemented separately from the prediction functionality, which may be implemented with separate hardware, software, and/or firmware.

Also included is a non-transitory computer-readable medium that stores a program that when executed by a computing device causes the computing device to receive a 3-dimensional simulation of an absorbent article. Additionally, the program may further cause the computing device to determine a deformation characteristic of the product, simulate an interaction of the inner part into the outer part, measure, from the interaction, a characteristic of interaction, and determine whether the characteristic of interaction meets a predetermined threshold. In response to determining that the characteristic of interaction meets the predetermined threshold, the program may cause the computing device to send an output that indicates the first 3-dimensional simulation and the second 3-dimensional simulation are acceptable product designs. In response to determining that the characteristic of interaction does not meet the predetermined threshold, the program may iteratively alter the 3-dimensional simulation until the characteristic of interaction meets the predetermined threshold.

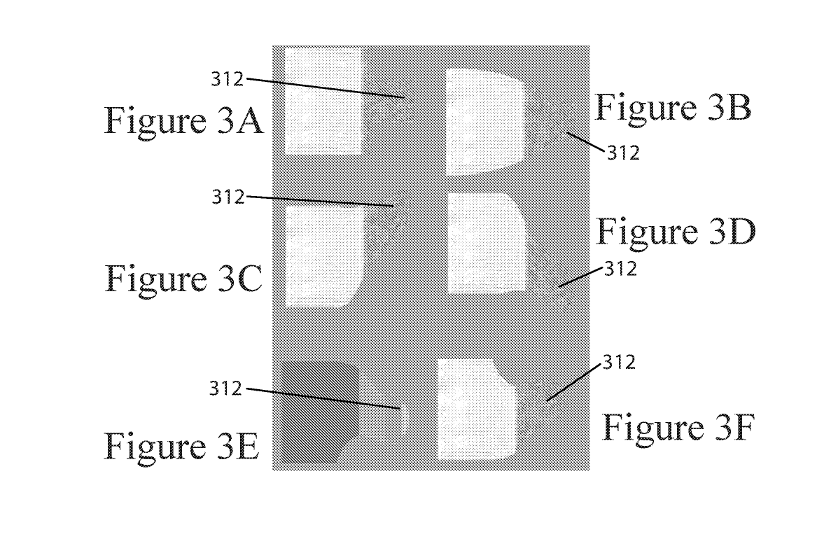

FIG. 3A-F shows perspective views a portion of an absorbent article, specifically the tab 312. As shown in the figures, various characteristics of the tab may be modified.

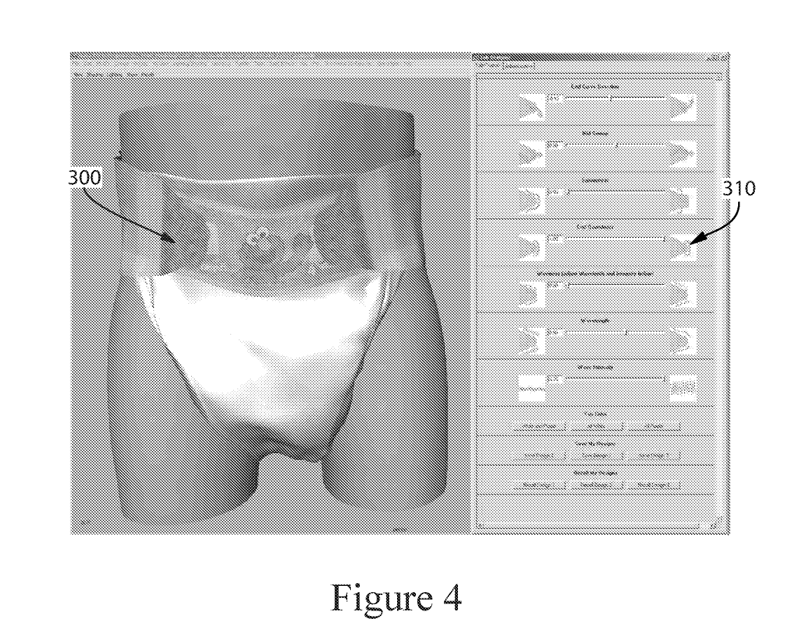

FIG. 4 represents an absorbent article 300 and the user interaction workflow 310. Specific model designs may be saved or recalled as needed, once saved. Designs may be sent to manufacturing to create a tangible absorbent article.

As shown in FIG. 4, the absorbent article 300 may be modified on based on the physical parameters chosen in the user interaction workflow 310. The user interaction workflow 310 may include the fastener position, the top height of the fastener, the bottom height of the fastener, the stretch height of the fastener, the squaring of the fastener, the curve direction of the fastener.

As shown in FIG. 4, the absorbent article 300 may be modified on based on the physical parameters chosen in the user interaction workflow 310. The user interaction workflow 310 may include the end cure direction of the tab, the mild swoop of the tab, the squareness of the tab, the end roundness of the tab, the waviness of the tab, the wavelength of the tab, or the tab color.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications may be made without departing from the spirit and scope of the invention. It is therefore intended to cover in the appended claims all such changes and modifications that are within the scope of this invention.

What is claimed is:

1. A method for making an absorbent article, comprising:
creating a computer based three dimensional simulation of an absorbent article comprised of a mesh made of one or more nodes;
building one or more deformation parameters for one or more discrete product attributes;
defining output requirements for the predictive three dimensional simulation;
rendering one or more frames of the predictive simulation appearance model; and
using the computer based predictive simulation to create the absorbent article.

2. The method of claim 1, wherein the method further comprises allowing a user to modify the predictive simulation appearance model prior to using the computer based predictive simulation to create the absorbent article.

3. The method of claim 1, wherein the method further includes manipulating the predictive three dimensional simulation.

4. The method of claim 1, wherein the predictive three dimensional simulation comprises of one or more modifiable physical attributes.

5. The method of claim 4, wherein the one or more physical attributes comprises of a fastener position, a top height of the fastener, a bottom height of the fastener, a stretch height of the fastener, a squaring of the fastener, a curve direction of the fastener, an end cure direction of the tab, a mild swoop of the tab, a squareness of the tab, an end roundness of the tab, a waviness of the tab, a wavelength of the tab, or a tab color.

6. The method of claim 1, wherein the defining the user interaction workflow comprises a set of sliders, simple switch buttons, or combinations thereof.

7. The method of claim 1, wherein the simulation deforms physical characteristics of the absorbent article until the user determines that the article is no longer acceptable.

8. The method of claim 7, wherein the simulation is repeated with a plurality of users to determine an acceptable range for each physical parameter of the three dimensional absorbent article.

9. The method of claim 1, wherein the method further utilizes iterative logic in response to one or more user inputs.

10. The method of claim 9, wherein the iterative logic adapts one or more design parameters to predict user input.

11. The method of claim 10, wherein the iterative logic iterates beyond a boundary of the initially defined space of the model.

12. A method for modeling an absorbent article using a computer, the method comprising:
creating a computer based three dimensional simulation of an absorbent article comprised of a mesh made of one or more nodes;
building one or more deformation parameters for one or more discrete product attributes;
defining output requirements for the predictive three dimensional simulation;
rendering one or more frames of the predictive simulation appearance model;
utilizing an iterative logic in response to one or more user inputs;
allowing the iterative logic to adapt one or more design parameters to predict user input; and
rendering one or more frames of an updated predictive simulation appearance model.

13. The method of claim 12, wherein the method further includes manipulating the predictive three dimensional simulation.

14. The method of claim 12, wherein the predictive three dimensional simulation comprises of one or more modifiable physical attributes.

15. The method of claim 14, wherein the one or more physical attributes comprises of a fastener position, a top height of the fastener, a bottom height of the fastener, a stretch height of the fastener, a squaring of the fastener, a curve direction of the fastener, an end cure direction of the tab, a mild swoop of the tab, a squareness of the tab, an end roundness of the tab, a waviness of the tab, a wavelength of the tab, or a tab color.

16. The method of claim 12, wherein the defining the user interaction workflow comprises a set of sliders, simple switch buttons, or combinations thereof.

17. The method of claim 12, wherein the simulation deforms physical characteristics of the absorbent article until the user determines that the article is no longer acceptable.

18. The method of claim 17, wherein the simulation is repeated with a plurality of users to determine an acceptable range for each physical parameter of the three dimensional absorbent article.

19. A method for modeling an absorbent article using a computer, the method comprising:
creating a computer based three dimensional simulation of an absorbent article comprised of a mesh made of one or more nodes;
building one or more deformation parameters for one or more discrete product attributes;
defining output requirements for the predictive three dimensional simulation;
rendering one or more frames of the predictive simulation appearance model;
allowing one or more users to manipulate one or more physical attributes of the model;
utilizing an iterative logic in response to one or more user inputs;
allowing the iterative logic to adapt one or more design parameters to predict user input; and
rendering one or more frames of an updated predictive simulation appearance model.

20. The method of claim 19, wherein the one or more physical attributes comprises of a fastener position, a top height of the fastener, a bottom height of the fastener, a stretch height of the fastener, a squaring of the fastener, a curve direction of the fastener, an end cure direction of the tab, a mild swoop of the tab, a squareness of the tab, an end roundness of the tab, a waviness of the tab, a wavelength of the tab, or a tab color.
